(19) United States
(12) Patent Application Publication
(10) Pub. No.: US 2023/0162084 A1
(43) Pub. Date: May 25, 2023

(54) SYSTEM AND METHOD FOR GENERATING SIGNAL IMAGES USING MULTI-MODAL SENSING SIGNAL

(71) Applicant: Electronics and Telecommunications Research Institute, Daejeon (KR)

(72) Inventors: You Jin KIM, Daejeon (KR); Jae Young JUNG, Daejeon (KR); Won Kyu CHOI, Daejeon (KR)

(73) Assignee: Electronics and Telecommunications Research Institute, Daejeon (KR)

(21) Appl. No.: 17/847,799

(22) Filed: Jun. 23, 2022

(30) Foreign Application Priority Data
Nov. 24, 2021 (KR) 10-2021-0163682

(51) Int. Cl. G06N 20/00; G01D 21/02

(52) U.S. Cl. CPC G06N 20/00; G01D 21/02

(57) ABSTRACT

A system for generating signal images using a multi-modal sensing signal includes a multi-modal combination unit configured to receive a plurality of heterogeneous sensing signals through a multi-modal sensor, mix the sensing signals, and slice the mixed signal based on a preset threshold value and an adaptive interval time, a signal image generation unit configured to generate each of signal images by converting each of the sliced signals into a predefined type and reassemble or reconfigure the generated signal images by inputting the generated signal images to a synthesizer, and a dataset generation unit configured to receive the signal images from the signal image generation unit and configure the received signal images as a ground truth dataset through logical memory links between the received signal images and inputted metadata.

### CROSS-REFERENCE TO RELATED APPLICATION

This application claims priority to and the benefit of Korean Patent Application No. 10-2021-0163682, filed on Nov. 24, 2021, the disclosure of which is incorporated herein by reference in its entirety.

### BACKGROUND

### 1. Technical Field

The present disclosure relates to a system and method for generating signal images using a multi-modal sensing signal.

### 2. Related Art

An artificial intelligence (AI) system is a computer system that implements human-level intelligence, and is a system in which a machine autonomously becomes smart by performing learning and decisions unlike the existing rule-based smart system.

The AI system has an increased recognition ratio and can more accurately understand a user taste as the AI system is used. Thus, the existing rule-based smart system has been gradually substituted with a deep learning-based AI system.

The AI technology consists of machine learning and element techniques using the machine learning. Various multi-modal data for learning is used for the AI technology.

However, in the case of multi-modal data, there is a difficulty in performing machine learning because representations for machine learning are configured in different forms due to heterogeneity between the multi-modal data (or sensing signals).

### SUMMARY

Various embodiments are directed to providing a system and method for generating signal images using a multi-modal sensing signal, which can provide, as ground truth training datasets for machine learning, multi-modal data including mutually heterogeneous sensing signals (e.g., text, radio waves, sounds, sound waves, light waves, temperatures, or humidity) by enabling the multi-modal data to be represented as signal image data projected onto the same space.

However, an object to be solved by the present disclosure is not limited to the aforementioned object, and other objects may be present.

A system for generating signal images using a multi-modal sensing signal according to a first aspect of the present disclosure includes a multi-modal combination unit configured to receive a plurality of heterogeneous sensing signals through a multi-modal sensor, mix the sensing signals, and slice the mixed signal based on a preset threshold value and an adaptive interval time, a signal image generation unit configured to generate each of signal images by converting each of the sliced signals into a predefined type and reassemble or reconfigure the generated signal images by inputting the generated signal images to a synthesizer, and a dataset generation unit configured to receive the signal images from the signal image generation unit and configure the received signal images as a ground truth dataset through logical memory links between the received signal images and inputted metadata.

Furthermore, a method of generating signal images using a multi-modal sensing signal according to a second aspect of the present disclosure includes receiving a plurality of heterogeneous sensing signals through a multi-modal sensor, mixing the plurality of received sensing signals, slicing the mixed signal based on a preset threshold value and an adaptive interval time, generating each of signal images by converting each of the sliced signals into a predefined type, reassembling or reconfiguring the generated signal images by inputting the generated signal images to a synthesizer, and configuring the signal images as a ground truth dataset through logical memory links between the signal images and metadata.

A computer program according to another aspect of the present disclosure executes the method of generating signal images using a multi-modal sensing signal in combination with a computer, that is, hardware, and is stored in a computer-readable recording medium.

Other details of the present disclosure are included in the detailed description and the drawings.

According to the aforementioned embodiment of the present disclosure, there are advantages in that the ease of execution of machine learning and learning accuracy can be significantly increased because multi-modal signals can be simultaneously represented as data in one space so that multi-modal data is sliced and generated in the same dimension in a way to be capable of generating a signal image and a large quantity of automated and accurate datasets can be generated.

The effects of the present disclosure are not limited to the above-mentioned effects, and other effects which are not mentioned herein will be clearly understood by those skilled in the art from the following descriptions.

### BRIEF DESCRIPTION OF THE DRAWINGS

FIG. 1 is a configuration diagram of a system for generating signal images according to an embodiment of the disclosure.

FIG. 2 is a diagram for describing a first embodiment to which the present disclosure is applied.

FIG. 3 is a diagram for describing a second embodiment to which the present disclosure is applied.

FIG. 4 is a diagram for describing a process of regulating, by an amplitude regulator of the present disclosure, signal amplitude.

FIG. 5 is a diagram for describing a ground truth dataset in an embodiment of the present disclosure.

FIG. 6 is a flowchart of a method of generating signal images according to an embodiment of the disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains of the category of the present disclosure. The present disclosure is merely defined by the category of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various elements, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

Hereinafter, in order to help understanding of those skilled in the art, a proposed background of the present disclosure is first described and an embodiment of the present disclosure is then described.

The human being has a multi-modal ability to see a thing, hear a sound, feel texture, have a scent, and feel the taste. Modality means a method of something occurring or experiencing something. Various modalities rather than a uni-modality are present in real life and are characterized as a multi-modality.

Artificial intelligence (AI) may provide more convenience to the human being only when AI can interpret such a multi-modal signal in understanding the world around the human being.

“Multi-modal machine learning” for AI means learning targeted on constructing a model capable of processing and associating information of several modalities. An initial multi-modal machine learning technology was focused on simply fusing modality information, whereas a current AI technology that becomes intelligent and sophisticated is developed into a technology for increasing understanding, such as a data expression method and the translation, arrangement, fusion, co-learning, etc. of data, in order to understand a correlation feature between uni-modals. The reason why the multi-modal machine learning technology is advanced as described above is that AI needs to interpret and infer a multi-modal message in order to understand the world around the human being.

In the representation of a multi-modal, data is represented by using information of several entities. However, several difficulties are present in order to represent a multi-modality.

Detailed examples of the difficulty include a method of combining data from heterogeneous sources, a method of processing noise having various levels, a method of processing omitted data, a method of representing heterogeneous data in a unified space, etc.

For example, a cough and sneeze of a person may have a point related to a moving displacement of the breast. Accordingly, association having higher accuracy may be discovered if a state of the person is checked along with the displacement of the breast, rather than checking the state based on only one type of data of the cough or sneeze.

As a more detailed example, a cough and a sneeze are important defense mechanisms of the body, and reflectionally occur when a stimulus to an airway including the larynx is present or occur in order to remove a foreign object within the lung and bronchus. Furthermore, a cough and a sneeze may occur due to a disease, such as a respiratory disease.

Such a cough or sneeze may be used as an important signal to determine whether the abnormality of the body has occurred because the sound signal of the cough or sneeze may be sensed in a non-invasive and contactless way. Furthermore, breathing monitoring through the acquisition of a displacement of the breast using a radar is a technology capable of sensing a fine movement of the breast as a phase change attributable to the reflection of radio waves in a non-invasive and contactless way, and may be used to sense a respiration rate. Whether an abnormal symptom in the body is present may be sensed during everyday life or sleep by sensing such a cough sound and a displacement of the breast.

In a conventional technology, however, the sensing of a cough sound and the sensing of a displacement of the breast are individually performed by a signal processing technology, or a cough sound and a displacement of the breast are sensed by independent modules or devices.

Furthermore, when whether the results of the sensing of a cough sound and a displacement of the breast are abnormal is classified through machine learning, a supervised learner plays a role in correctly guessing a value of given data to be predicted among training data. In this case, ground truth training datasets, such as ground truth labels, are required.

However, the setting of a ground truth label in the same condition is not easy because a cough sound, that is, an audio signal, and a sensing signal of a displacement of the breast, that is, a radar signal including a reflected and received signal of a transmitted radio wave signal, belong to different signal methods.

If respiration rates according to a cough sound and a displacement of the breast are simultaneously monitored, accuracy may be further increased because information on the relationship between two signals can be used, rather than sensing whether an abnormal symptom is present based on one type of signal.

However, a multi-modal signal having different signal inputs has a problem in that data representations for the machine learning are performed in different forms due to heterogeneity between data, which makes machine learning difficult.

For another example, the accuracy of the discovery of a feature may be further increased if a surrounding environment sensing signal (e.g., CO₂, a temperature, humidity, or a speed sensing signal) is associated with noise caused by a worker or a machine sound in an industrial site.

As a more detailed example, noise caused by a worker or a machine sound in an industrial site has various sound intensities which are integrated and inputted. In a conventional technology, a target specific frequency component is analyzed through a pre-processing process, such as extracting a specific frequency component of a sound by using a signal processing technology.

However, if a feature is to be discovered in association with an environment sensing signal, there is inconvenience, such as a process of processing signals based on features of individual input devices of environment sensing devices and analyzing association therebetween.

As described above, the conventional technology has a problem in that data representations for the machine learning are performed in different forms due to heterogeneity between signals, which makes the execution of machine learning difficult.

In order to solve such a problem, a system and method for generating signal images using a multi-modal sensing signal according to an embodiment of the disclosure may generate and provide ground truth training datasets that enable machine learning, such as a convolutional neural network (CNN), by enabling multi-modal data having different spaces to be represented as signal images in which the multi-modal data can be projected onto one space.

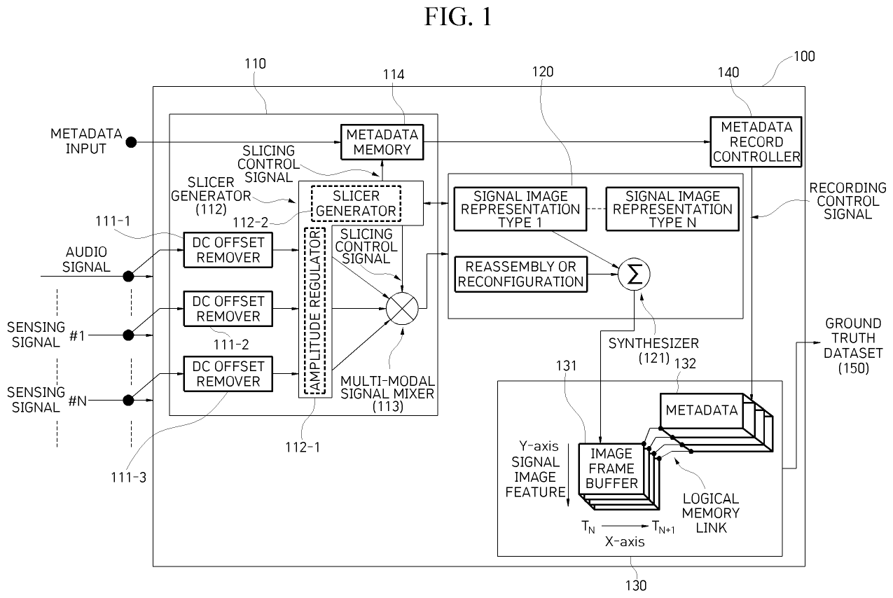

Hereinafter, a system 100 for generating signal images using a multi-modal sensing signal according to an embodiment of the disclosure is described with reference to FIGS. 1 to 5.

FIG. 1 is a configuration diagram of the system 100 for generating signal images according to an embodiment of the disclosure.

The system 100 for generating signal images according to an embodiment of the disclosure may include a multi-modal combination unit 110, a signal image generation unit 120, and a dataset generation unit 130.

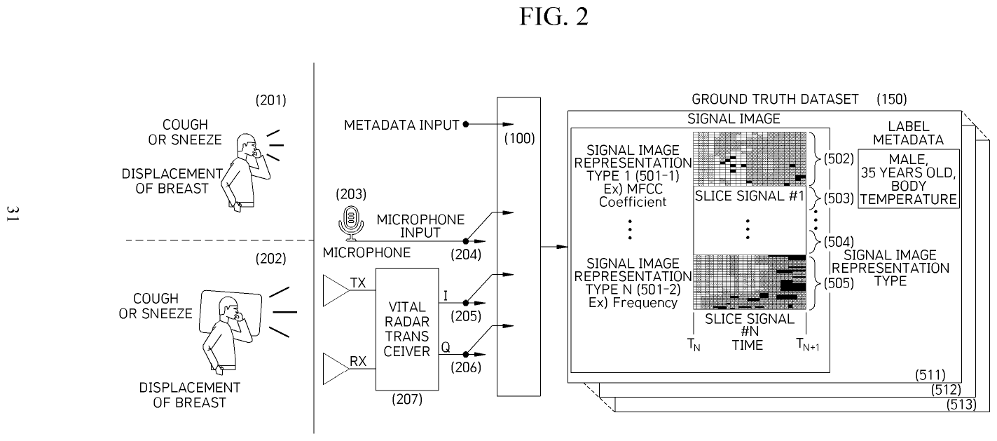

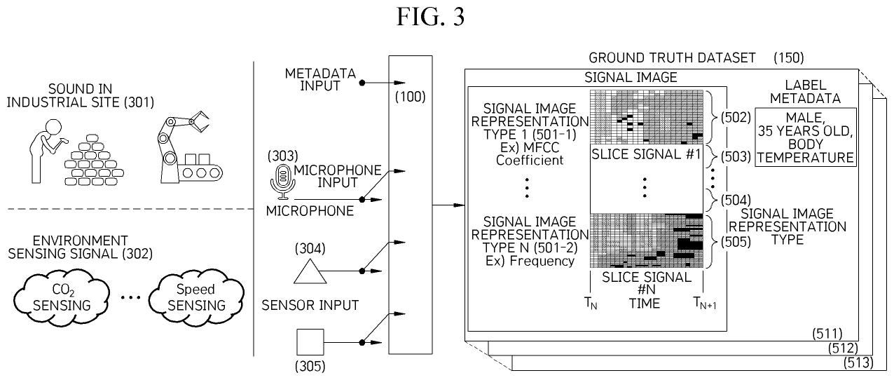

The multi-modal combination unit 110 receives plurality of heterogeneous sensing signals through a multi-modal sensor. In FIG. 1, it has been illustrated that an audio signal and various other sensing signals Sensor #1 Signal and Sensor #2 Signal are received, but the present disclosure is not essentially limited thereto. An example in which sensing signals are received through the multi-modal sensor is described as follows with reference to FIGS. 2 and 3.

FIG. 2 is a diagram for describing a first embodiment to which the present disclosure is applied.

The system 100 for generating signal images according to the present disclosure may receive various inputs from a sensor which may have a multi-modal configuration. As illustrated in FIG. 2, the system 100 receives an input 204 of a microphone 203 for sensing a cough or sneeze 201 of a person in everyday life, and input signals (e.g., inphase (I) and quadrature (Q) signals 205 and 206) of a vital radar transceiver 207 for sensing a movement displacement of the breast of a person.

Furthermore, the system 100 receives the sensing of a cough or sneeze and a displacement of the breast of a sleeping person as an input (202).

In this case, according to an embodiment of the present disclosure, the system 100 may also receive information that describes features of input signals corresponding to a user, that is, metadata.

According to an embodiment of the present disclosure, the system 100 may generate a ground truth dataset 150 in which data is represented as signal images based on such input signals.

FIG. 3 is a diagram for describing a second embodiment to which the present disclosure is applied.

According to an embodiment of the present disclosure, the system 100 senses a sound 301 in an industrial site as an input of a microphone 303, and receives environment sensing signals (e.g., CO2, a temperature, humidity, and a speed sensing signal) 302 as sensor inputs 304 and 305.

The system 100 may generate a ground truth dataset 150 as the results of an operation of the present disclosure based on such sensing signals.

Referring back to FIG. 1, the multi-modal combination unit 110 removes DC offsets from the inputted sensing signals for each input signal through DC offset removers 111-1, 111-2, and 111-3, respectively. A signal from which the DC offset has been removed is inputted to an amplitude regulator 112-1 of a slicer generator 112 within the multi-modal combination unit 110.

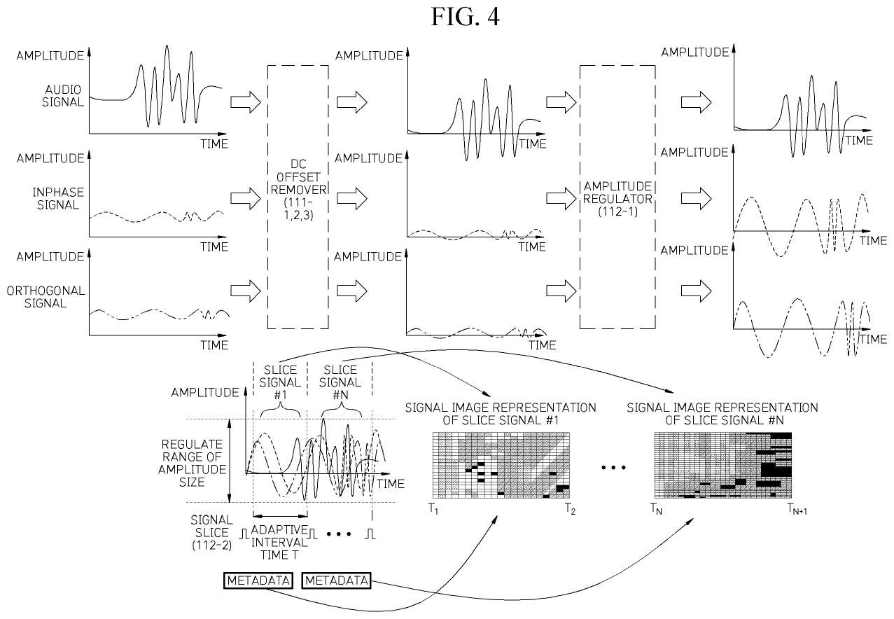

FIG. 4 is a diagram for describing a process of regulating, by the amplitude regulator 112-1 of the present disclosure, signal amplitude.

In an embodiment of the present disclosure, the amplitude regulator 112-1 has different amplitude for each sensing signal from which a DC offset has been removed as illustrated in FIG. 4, and automatically regulates an effective amplitude range based on a threshold value of a range defined by a user and maximum amplitude.

In an embodiment, the amplitude regulator 112-1 may regulate amplitudes of a plurality of the remaining second sensing signals based on maximum amplitude of a first sensing signal among a plurality of sensing signals. In this case, a sensing signal having the greatest effective amplitude range among the plurality of sensing signals may be selected as the first sensing signal. As described above, according to an embodiment of the present disclosure, the amplitude regulator 112-1 may amplify a small signal among the plurality of second sensing signals based on maximum amplitude of the first sensing signal.

As described above, an amplitude signal modified from an initial raw input signal is mixed through a multi-modal signal mixer 113. The mixed signal is sliced through a signal slicer 112-2 included in the multi-modal combination unit 110. That is, the signal slicer 112-2 slices the mixed signal by outputting a slicing control signal so that the mixed signal is sliced at adaptive interval times based on a threshold value defined by a user.

In this case, the threshold value defined by the user may be set as a maximum value by which a user may previously obtain a feature of a multi-modal input signal and set the adaptive interval time. Based on the threshold value, the signal slicer 112-2 may adaptively control the interval of a time on the basis of the cycle of a major frequency component of the mixed signal. As a result, the output of the multi-modal signal mixer 113 is inputted to the signal image generation unit 120.

In the present disclosure, the functions of the amplitude regulator 112-1 and the signal slicer 112-2 may be combined to form the slicer generator 112.

The signal image generation unit 120 generates the sliced signals as respective signal images by converting the sliced signals into a predefined type. In this case, examples of the predefined type may include Mel-frequency cepstral coefficients (MFCC), a frequency, a spectrum, etc. In the present disclosure, a signal image representation type is not limited to a specific type.

The signal image generation unit 120 synthesizes, through a signal image reassembly or reconfiguration function, the signal images converted through a signal image representation type conversion function by inputting the signal images into a synthesizer 121.

In this case, the signal image reassembly or reconfiguration function means that the signal images are reassembled or reconfigured through a method, such as shuffling or interleaving the sequence of the generated signal images through the signal image representation type conversion function.

The output of the signal images generated through the synthesizer 121 as described above is inputted to the dataset generation unit 130.

Next, the dataset generation unit 130 receives the signal images and constructs the received signal images as a ground truth dataset through logical memory links between the received signal images and metadata.

In an embodiment, metadata inputted by a user is stored in a metadata memory 114 within the multi-modal combination unit 110. The stored metadata is outputted by being synchronized with sliced signals, that is, the output of the multi-modal signal mixer 113, in response to a slicing control signal of the slicer generator 112 based on an adaptive interval time.

The output of the metadata memory 114 within the multi-modal combination unit 110, which has been synchronized with the slicing control signal, is inputted to a metadata record controller 140. The metadata record controller 140 receives the synchronized metadata, and outputs a recording control signal that enables logical memory links with signal images.

The dataset generation unit 130 includes image frame buffers 131 and metadata 132 for an image frame having a logical memory link for each image frame. In this case, the dataset generation unit 130 may construct the image frame buffers 131 determined based on the sizes of a first axis (e.g., a Y axis) including feature sizes of signal images (i.e., signal image features) and a second axis (e.g., an X axis) including adaptive interval times, and may construct the metadata 132 as a ground truth dataset 150 by making logical memory links with the metadata 132 for each image frame buffer 131.

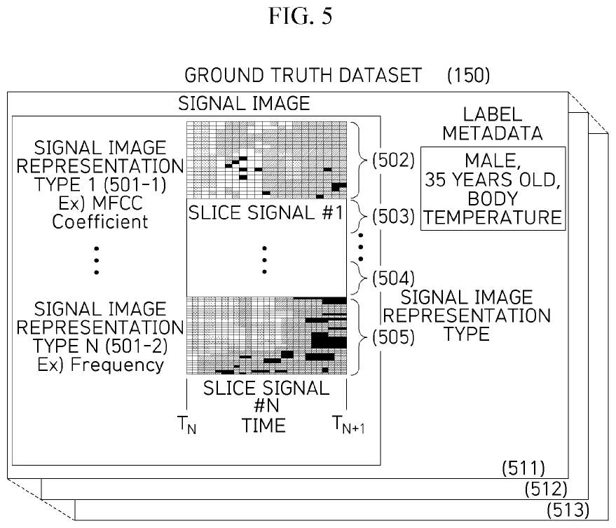

FIG. 5 is a diagram for describing the ground truth dataset 150 in an embodiment of the present disclosure.

A signal image representation type 1 501-1 means a signal image representation of a slice signal #1. A signal image representation type N 501-2 means a signal image representation of a slice signal N.

Furthermore, T_{N} and T_{N+1} mean adaptive interval times generated by the signal slicer 112-2.

As described above, according to an embodiment of the present disclosure, the sequence of generated signal images is shuffled or interleaved through the signal image reassembly or reconfiguration process. For example, in FIG. 5, the signal images may be sequentially arranged like 502, 503, 504, and 505 or may be combined, reassembled, or reconfigured in various types, such as the sequence in which the signal images are shuffled like 502, 504, 503, and 505.

The ground truth dataset 150 includes metadata called a label. As in the example of FIG. 5, a dataset defined by a user, such as sex, an age, and a body temperature, may be inputted to the metadata. Such metadata is connected to an image frame as a pair, and includes a plurality of datasets 511, 512, and 513.

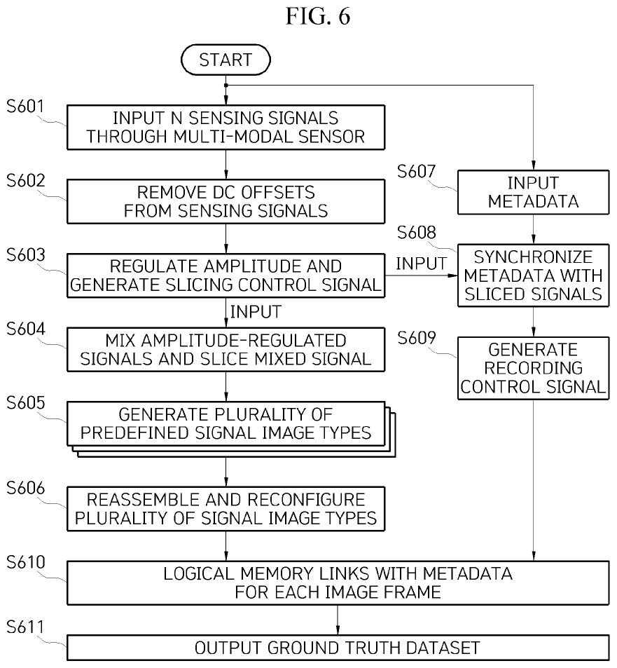

Hereinafter, a method of generating signal images using a multi-modal sensing signal according to an embodiment of the disclosure is described with reference to FIG. 6.

FIG. 6 is a flowchart of a method of generating signal images according to an embodiment of the disclosure.

It may be understood that each of steps illustrated in FIG. 6 is performed by the aforementioned system 100 for generating signal images, but the present disclosure is not essentially limited thereto.

First, when receiving a plurality of heterogeneous sensing signals through the multi-modal sensor (S601), the system 100 removes DC offsets from the inputted sensing signals (S602).

Thereafter, the amplitude regulator 112-1 within the slicer generator performs a process of regulating amplitude of each of the signals from which the DC offsets have been removed (S603).

Next, the signals whose amplitude has been regulated are mixed. The mixed signal is sliced based on an adaptive interval time through the signal slicer 112-2 (S604).

Next, each of signal images is generated by converting the sliced signal into a predefined type (S605). The signal images are reassembled or reconfigured by inputting the signal images to the synthesizer 121 (S606).

According to an embodiment of the present disclosure, metadata may be inputted. The inputted metadata is stored in the metadata memory 114 (S607).

The metadata is synchronized with the sliced signals based on the adaptive interval time (S608), As a result, the metadata is subjected to logical memory links (S610) for each finally generated image frame based on a recording control signal outputted through the metadata record controller 140 (S609), so that the metadata is outputted as ground truth datasets (S611).

In the aforementioned description, steps S601 to S611 may be further divided into additional steps or may be combined into smaller steps depending on an implementation example of the present disclosure. Furthermore, some steps may be omitted, if necessary, and the sequence of steps may be changed. Furthermore, although contents are omitted, the contents of FIGS. 1 to 5 may also be applied to the method of generating signal images in FIG. 6.

The aforementioned embodiment of the present disclosure may be implemented in the form of a program (or application) in order to be executed by being combined with a computer, that is, hardware, and may be stored in a medium.

The aforementioned program may include a code coded in a computer language, such as C, C++, JAVA, Ruby, or a machine language which is readable by a processor (CPU) of a computer through a device interface of the computer in order for the computer to read the program and execute the methods implemented as the program. Such a code may include a functional code related to a function, etc. that defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and readably by a device, not a medium storing data for a short moment like a register, cache, or a memory. Specifically, examples of the stored medium include a ROM, a RAM, a CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

What is claimed is:

1. A system for generating signal images using a multi-modal sensing signal, the system comprising:
a multi-modal combination unit configured to receive a plurality of heterogeneous sensing signals through a multi-modal sensor, mix the sensing signals, and slice the mixed signal based on a preset threshold value and an adaptive interval time;
a signal image generation unit configured to generate each of signal images by converting each of the sliced signals into a predefined type and reassemble or reconfigure the generated signal images by inputting the generated signal images to a synthesizer, and
a dataset generation unit configured to receive the signal images from the signal image generation unit and configure the received signal images as a ground truth dataset through logical memory links between the received signal images and inputted metadata.

2. The system of claim 1, wherein the multi-modal combination unit comprises:
DC offset removers configured to remove DC offsets from the plurality of sensing signals, respectively; and
a slicer generator comprising an amplitude regulator configured to regulate amplitude of each of the plurality of sensing signals and a signal slicer configured to slice the mixed signal.

3. The system of claim 2, wherein the amplitude regulator regulates amplitudes of a plurality of second sensing signals based on maximum amplitude of a first sensing signal among the plurality of sensing signals.

4. The system of claim 2, wherein the signal slicer sets the adaptive interval time based on a cycle of a frequency component of the mixed signal and performs slicing.

5. The system of claim 1, wherein:
the multi-modal combination unit comprises a metadata memory for storing the inputted metadata and outputs the stored metadata by synchronizing the stored metadata with the signals sliced based on the adaptive interval time, and
the system further comprises a metadata record controller configured to receive the synchronized metadata from the multi-modal combination unit and output a recording control signal which enables the logical memory links with the signal images.

6. The system of claim 5, wherein the dataset generation unit constructs image frame buffers determined based on sizes of a first axis comprising feature sizes of the signal images and a second axis comprising the adaptive interval times, and constructs the metadata as the ground truth dataset by subjecting the metadata to the logical memory links for each image frame buffer.

7. A method of generating signal images using a multi-modal sensing signal, the method performed by a computer comprising:
receiving a plurality of heterogeneous sensing signals through a multi-modal sensor;
mixing the plurality of received sensing signals;
slicing the mixed signal based on a preset threshold value and an adaptive interval time;
generating each of signal images by converting each of the sliced signals into a predefined type;
reassembling or reconfiguring the generated signal images by inputting the generated signal images to a synthesizer; and
configuring the signal images as a ground truth dataset through logical memory links between the signal images and metadata.

8. The method of claim 7, further comprising removing DC offsets from the plurality of sensing signals.

9. The method of claim 7, further comprising regulating amplitudes of the plurality of sensing signals.

10. The method of claim 9, wherein the regulating of the amplitudes of the plurality of sensing signals comprises regulating amplitudes of a plurality of second sensing signals based on maximum amplitude of a first sensing signal among the plurality of sensing signals.

11. The method of claim 7, wherein the slicing of the mixed signal based on the preset threshold value and the adaptive interval time comprises:
setting the adaptive interval time based on a cycle of a frequency component of the mixed signal, and
slicing the mixed signal.

12. The method of claim 7, wherein the reassembling or reconfiguring of the generated signal images by inputting the generated signal images to the synthesizer comprises reassembling or reconfiguring the signal images by shuffling or interleaving a sequence of the generated signal images.

13. The method of claim 7, further comprising:
inputting and storing the metadata;
synchronizing the metadata with the sliced signals based on the adaptive interval time; and
outputting a recording control signal which enables the logical memory links between the synchronized metadata and the signal images.

14. The method of claim 13, wherein the configuring of the signal images as the ground truth dataset through the logical memory links between the signal images and metadata the metadata comprises:
constructing image frame buffers for the signal images; and
subjecting the metadata to the logical memory links for each image frame buffer.

15. The method of claim 14, wherein the constructing of the image frame buffers for the signal images comprises constructing the image frame buffers determined based on sizes of a first axis comprising feature sizes of the signal images and a second axis comprising the adaptive interval times.
